(19) United States
(12) Patent Application Publication
(10) Pub. No.: US 2025/0290693 A1
(43) Pub. Date: Sep. 18, 2025

(54) HYBRID DRYING OF INDUSTRIAL GOODS

(71) Applicant: MEAM BV, Houthalen-Helchteren (BE)

(72) Inventors: Carlo GROFFILS, Herent (BE); Karel GROFFILS, Herent (BE); Minh Cuong TRAN, Heverlee (BE); Lena KAIPIA, Heverlee (BE)

(73) Assignee: MEAM BV, Houthalen-Helchteren (BE)

(21) Appl. No.: 18/860,048

(22) PCT Filed: Apr. 26, 2023
(86) PCT No.: PCT/EP2023/061002

§ 371 Date: Oct. 25, 2024

(30) Foreign Application Priority Data
Apr. 26, 2022 (EP) 22170137.8

(51) Int. Cl. F26B 3/34; F26B 3/347; F26B 17/04; F26B 17/08; F26B 21/08

(52) U.S. Cl. CPC F26B 3/343; F26B 3/347; F26B 17/04; F26B 17/08; F26B 21/086; F26B 2200/08; F26B 2200/10; F26B 2200/14

(57) ABSTRACT

The present disclosure relates to technology for hybrid drying of industrial goods. Specifically, technology is described by means of which the thermal and electrical efficiency of a hybrid drying system can be improved. An aspect of the present disclosure relates to a method for energy-efficient hybrid drying of industrial goods such as raw materials, the drying method comprising the steps: —providing a wet product; —preconditioning the product by successively exposing it to a first air circulation circulated through a first air circulation device, and a second air circulation circulated through a second air circulation device; —hybrid drying the product by simultaneously exposing it to microwaves generated by a microwave drying device and a third air circulation circulated through said microwave drying device; —whereby the second air circulation comprises the spent first air circulation that is warmed up and dehumidified using a heat pump system such that the second air circulation has a lower relative humidity and a higher temperature than the first air circulation; —whereby the first air circulation comprises the spent third air circulation, that is warmed up and humidified in the microwave drying device such that the first air circulation has a higher relative humidity and a higher temperature than the third air circulation.

### FIELD OF THE INVENTION

The present disclosure relates to technology for hybrid drying of industrial goods. Specifically, technology is described by means of which the thermal and electrical efficiency of a hybrid drying system can be improved.

### BACKGROUND

Microwave (MW) drying technology has come a long way from the sixties when the first commercial MW drying devices were developed. MW drying technology has been broadly applied in a wide array of industrial applications exploiting the thermal effects of the substance absorbing MWs to trigger moisture removal. When the internal temperature of a substance rises, material surface moisture evaporation occurs as consequence drying the substance.

At present, different generations of MW drying technology can be distinguished with increasing energy efficiency levels, the first being MW drying systems where only MWs are used to heat the substrate and with a drying efficiency of around 63% in converting electrical energy to microwaves, this means 37% of the electric energy is lost as waste heat. The next generation is a hybrid “oven”, employing both MW and warm air in the MW cavity to improve the drying conditions. In such systems, the warmed air originates from the air-cooled magnetrons, which aims to repurpose at least part of the lost waste heat (i.e., the 37% of the electric energy), and as such requires less additional energy input. The newest generations can further comprise heat recovery devices positioned on the exhaust air and/or cooling water loop to preheat the air going into the MW cavity.

However, the suitability and efficiency of the above-described systems depends on the industrial process and environmental conditions, so it is not always possible to use them. Specifically, earlier generations are very limited by their configuration, which puts a serious limitation on the achievable process speed and efficiency. For example, systems that are optimised for energy efficiency cannot be adapted to increase/decrease the flow speed, or adapt specific conditions for different product, such as changes in humidity level or other temperature ranges.

In practice, while some drying systems in the art use warm air to heat the surface of a produce, MW drying systems of the art typically rely on cooler air to decrease the surface temperatures of the product for evaporative cooling. Nevertheless, if the dielectric loss factor of the product is high enough, the limiting factor in the drying process is not the speed of the energy transfer but rather the speed of mass transfer.

As long as the absorbed microwave power is higher than the energy lost due to evaporation, the product can continue to heat up eventually reaching the maximum process temperature.

However, when this maximum process temperature is low (e.g. sensitive food products), this put a serious limit to the drying speed and as consequence on the economic viability of such solutions. Furthermore, the complexity of the environmental conditions adds extra limitation to the drying speed of the systems in the art. The varying level of air humidity and temperature, as well as the product intrinsic properties, put a serious threat towards the capability of such drying systems to cope with such swinging parameters which render the process highly dependent on such parameters, and as such decreases the efficiency and economic viability of such systems.

Accordingly, there is a need for methods and systems for hybrid drying which leverage an improved drying efficiency as compared to the present methods and systems which. Furthermore, there is a need for methods and systems for hybrid drying of material that is very wet and cold to realise a higher degree of suitability in a wide array of industrial processes through improved energy efficiency.

### SUMMARY OF THE INVENTION

As described above, there is a need to remedy the issues and limitations of state of art methods and systems for drying of industrial goods to increase their efficiency, and to enforce suitability to a wide range of industrial applications/goods.

To present disclosure relates to technology to dry or dehydrate raw material, such as granulated slag, sand, grass or wood clippings, and so on. It is common for raw material to be stored in outside conditions, which causes the material to get very cold and wet, sometimes frozen. One problem when applying microwaves directly onto a wet and cold material is that the evaporative drying process effectuated by applying microwaves is slow and inefficient because the product is essentially warmed up from the outside-in, which for certain types of material might even cause damage; for example, when the material is an insulator or in a frozen state. On the other hand, convective drying alone is less energy efficient than microwave drying and similarly heats form the outside-in

To improve the drying efficiency of such material, the present disclosure proposes a specific drying process by which a wet and advantageously cold product is successively exposed to a number of independent air circulations that have a different temperature and a different humidity. An advantage of this drying process is that a wet and cold product can be preconditioned towards a warm and surface dry state that allows for a faster and more energy efficient evaporative drying by microwaves. As such, the risk of damaging the material through overheating its surface from the outside-in is minimised. This makes the present drying process particularly suitable for the drying of completely frozen products or insulator material, such as the aforementioned grass or wood clippings. Moreover, the present disclosure proposes an implementation of the air circulations in a way that the difference in air temperature and humidity for one air circulation is realised by capturing and diverting spent air from another air circulation. In this way the drying efficiency of raw materials can be improved to accelerate the overall drying process while at the same time improving the overall energy efficiency of the drying system.

A first overview of various components of the invention according to the present disclosure is given hereinbelow, after which specific embodiments will be described in more detail. This first overview is meant to aid the reader in understanding the technological concepts more quickly, but it is not meant to identify the most important or essential features thereof, nor is it meant to limit the scope of the present invention.

An aspect of the present disclosure relates to a method for energy-efficient hybrid drying of industrial goods such as raw materials, said drying method comprising the steps:
(a) providing a wet product;
(b) air-drying the wet product by circulating a first hot drying air in order to obtain a first preheated product, and capturing the spent air;
(c) air-drying the first preheated product by circulating a second hot drying air in order to obtain a second preheated product;
(d) microwave and air-drying the second preheated product by means of a microwave drying device through which a third hot drying air is circulated in order to obtain a dried product, and capturing the spent air;
   whereby the first hot drying air used in step (b) comprises the spent air from step (d);
   whereby the second hot drying air used in step (c) comprises the spent air from step (b) which is heated and dried by means of a heat pump system (30); and,
   whereby the third hot drying air used in step (d) comprises air which is heated using waste heat from the microwave drying device (20).

In some embodiments the third hot drying air is heated during the microwave drying such that the captured spent air has a higher temperature than the provided third hot drying air.

In some embodiments the third hot drying air used in step (d) comprises outside air and/or the spent air from step (c).

In some embodiments the third hot drying air comprises at least 20% vol. of the spent air from step (c), preferably 45% vol., more preferably 50% vol., even more preferably 55% vol.

In some embodiments the spent air from step (b) is split into at least two air portions in the heat pump system, including a first air portion which passes through an evaporator, and a second air portion which bypasses said evaporator and is mixed with the first air portion having passed through the evaporator to obtain mixed air; and whereby said mixed air passes through a condenser and is heated obtain the second hot drying air.

In some embodiments the mixed air is heated by a heating element, preferably an electric heater.

In some embodiments the first hot drying air used in step (b) is heated by a heating element.

In some embodiments the first hot drying air used in step (b) is heated with heat the heat pump system, or heated by a heating element powered by energy from the heat pump system.

In some embodiments the first air portion comprises at least 40% vol. of the spent air, preferably 45% vol., more preferably 50% vol., even more preferably 55% vol.

Another aspect of the present disclosure relates to a method for energy-efficient hybrid drying of industrial goods such as raw materials, said drying method comprising the steps:
providing a wet product;
preconditioning the product by successively exposing it to a first air circulation circulated through a first air circulation device, and a second air circulation circulated through a second air circulation device;
hybrid drying the product by simultaneously exposing it to microwaves generated by a microwave drying device and air circulated through the microwave drying device;
whereby the second air circulation circulated in the second air circulation device comprises the spent air from the first air circulation device, that is warmed up and dehumidified using a heat pump system such that the second air circulated in the second air circulation device has a lower relative humidity and a higher temperature than the first air circulation circulated in the first air circulation device;
whereby the first air circulation circulated in the first air circulation device comprises the spent air from the microwave drying device, that is warmed up and humidified in the microwave drying device such that the air circulated in the first air circulation device has a higher relative humidity and a higher temperature than the third air circulation circulated through the microwave drying device.

In some embodiments the first air circulation device and the second air circulation device are arranged such that the first air circulation cannot pass directly from the first air circulation device into the second air circulation device and/or the second air circulation cannot pass directly from the second air circulation device into the first air circulation device.

In some embodiments the third air circulation comprises outside air and/or the spent second air circulation, preferably warmed up with waste heat from the microwave drying device.

In some embodiments the third air circulation comprises at least 5% vol of the spent air from the second air circulation device, preferably at least 10% vol., more preferably at least 15% vol., more preferably still at least 20% vol., more preferably still at least 25% vol., more preferably still at least 30% vol., more preferably still at least 30% vol., more preferably still at least 35% vol., more preferably still at least 40% vol., more preferably still at least 50% vol., more preferably still at least 55% vol., more preferably still at least 60% vol., more preferably still at least 65% vol., more preferably still at least 70% vol., more preferably still at least 75% vol.

In some embodiments the third air circulation does not comprise any of the spent air from the second air circulation device, that is, the third air circulation comprises 0% vol of the spent air from the second air circulation device.

In some embodiments the first air circulation is further warmed up by a heating element.

In some embodiments the spent air from the first air circulation device is split into at least two air portions by the heat pump system, including a first air portion which passes through an evaporator, and a second air portion which bypasses said evaporator and is mixed with the first air portion having passed through the evaporator to obtain mixed air; and whereby said mixed air passes through a condenser and is heated obtain the second air circulation.

In some embodiments the first air portion comprises at least 50% vol. of the spent air from the first air circulation device, preferably 60% vol., more preferably 70% vol., even more preferably 80% vol; even more preferably still 90% vol.; even more preferably still 100% vol.

Another aspect of the present disclosure relates to a system for energy-efficient hybrid drying of industrial goods such as raw materials, said drying system comprising:
a conveyor device configured for transporting of a product throughout the hybrid drying system;
a first convective drying device configured for circulating a first hot drying air over a wet product in order to obtain a first preheated product;
a second convective drying device configured for circulating a second hot drying air over the first preheated product in order to obtain a second preheated product;
a microwave drying device configured for microwave drying and circulating a third hot drying air over the second preheated product in order to obtain a dried product;
a heat pump system configured for heating and drying of spent air;
whereby the first hot drying air circulated in the first convective drying device comprises spent air from the microwave drying device;
whereby the second hot drying air circulated in the second convective drying device comprises the spent air from the first convective drying device, which is heated and dried by means of the heat pump system;
whereby the third hot drying air circulated in the microwave drying device comprises air which is heated using waste heat from the microwave drying device.

In some embodiments the system comprises a heating element configured to heat outside air and/or spent air in order to obtain hot drying air.

In some embodiments the microwave drying device is configured to further heat and dry the third hot drying air during the microwave drying such that the spent air has a higher temperature than the provided hot drying air.

In some embodiments the system comprises a heating element configured to heat outside air and/or spent air in order to obtain hot drying air.

In some embodiments the heating element is provided with heat from the heat pump system and/or is powered by energy provided by the heat pump system.

In some embodiments the heat pump system comprises an evaporator and a condenser, whereby the spent air from the first convective drying device is split into at least two air portions, including a first air portion which is passed through the evaporator, and a second air portion which bypasses said evaporator and is mixed with the first air portion having passed through the evaporator to obtain mixed air; and whereby said mixed air is passed through a condenser and heated to obtain the second hot drying air.

Another aspect of the present disclosure relates to a system for energy-efficient hybrid drying of industrial goods such as raw materials, the hybrid drying system comprising:
a preconditioning system comprising a first air circulation device configured for exposing a product to a first air circulation, and a second air circulation device configured for exposing the product to a second air circulation;
a heat pump system configured for receiving spent air from the first air circulation device, warming and dehumidifying said spent air, and feeding it to the second air circulation device such that the air of the second air circulation has a lower relative humidity and a higher temperature than the air of the of the first air circulation;
a microwave drying system comprising a microwave generator for generating microwaves, a microwave emission source configured for exposing the product to the generated microwaves, and a third air circulation device configured for simultaneously exposing the product to a third air circulation;
an air circulation means configured to receive spent air from the microwave drying system, which is warmed up and humidified in the microwave drying device, and feeding it to the first air circulation device such that the first air circulation has a higher relative humidity and a higher temperature than the third air circulation; and,
a conveyor means configured to convey a product successively through the first air circulation device, the second air circulation device and the microwave drying device.

In some embodiments preconditioning system is arranged such that the first air circulation cannot pass directly from the first air circulation device into the second air circulation device and/or the second air circulation cannot pass directly from the second air circulation device into the first air circulation device.

In some embodiments the first convective drying device and the second convective drying device are arranged such that the first drying air cannot pass directly from the first convective drying device into the second convective drying device and/or the second drying air cannot pass directly from the second convective drying device into the first convective drying device.

In some embodiments the third air circulation comprises outside air and/the spent air from the second air circulation device, that is preferably warmed up with waste heat from the microwave drying device (20).

In some embodiments the hybrid drying system comprises at least one heating element configured to warm up provided air.

In some embodiments the heat pump system comprises an evaporator and a condenser whereby the spent air from the first air circulation device is split into at least two air portions, including a first air portion which is passed through the evaporator, and a second air portion which bypasses said evaporator and is mixed with the first air portion having passed through the evaporator to obtain mixed air; and whereby said mixed air is passed through a condenser and warmed to obtain the second air circulation.

In some embodiments the conveyor device comprises a conveyor belt and/or a screw conveyor.

In some embodiments the system comprises one or more solar panels configured to supply power to one or more components of said system.

Another aspect of the present disclosure relates to a use of a system for the energy-efficient hybrid drying of industrial goods such as raw materials.

In some embodiments the raw materials comprise products from the mining or refinement industry, preferably granulated slag, sand or other minerals.

In some embodiments the raw materials comprise products from the food or agricultural industry, preferably raw food products such as fruit or harvest, grass or wood clippings, and so on.

### DESCRIPTION OF THE FIGURES

The following description of the figures relate to specific embodiments of the disclosure which are merely exemplary in nature and not intended to limit the present teachings, their application or uses.

Throughout the drawings, the corresponding reference numerals indicate the following parts and features: hybrid drying system (1); conveyor device (5); preconditioning system (10); first air circulation device (11); second air circulation device (12); microwave drying device (20); microwave cavity (21); heat pump system (30); evaporator (31); condenser (32); heating element (35); heating element (40).

FIG. 1 is a flowchart illustrating a method for hybrid drying of a product according to a preferred embodiment.

FIG. 2 is a flowchart further illustrating the heat pump system (30) of FIG. 1.

FIG. 3 is a flowchart further illustrating the microwave drying device (20) of FIG. 1.

FIG. 4 is a block chart representing the components of a hybrid drying system (1) according to an embodiment thereof.

FIG. 5 is a block chart representing the components of a hybrid drying system (1) according to another embodiment thereof.

FIG. 6 is an illustration of a part of the hybrid drying system (1) of the present disclosure.

FIG. 7 is a flowchart illustrating an exemplary energy calculation for the product flow passing through a hybrid drying system (1) according to a preferred embodiment thereof.

FIG. 8 is a flowchart showing the theoretical energy calculation for the air flow passing through the heat pump system (30) of FIG. 7.

FIG. 9 is a flowchart showing the theoretical energy calculation for the air flow going into the microwave drying device (20) of FIG. 7.

### DETAILED DESCRIPTION

In the following detailed description, the technology underlying the present disclosure will be described by means of different aspects thereof. It will be readily understood that the aspects of the present disclosure, as generally described herein, and illustrated in the figures, can be arranged, substituted, combined, and designed in a wide variety of different configurations, all of which are explicitly contemplated and make part of this disclosure. This description is meant to aid the reader in understanding the technological concepts more easily, but it is not meant to limit the scope of the present disclosure, which is limited only by the claims.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment.

As used herein, the terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” when referring to recited members, elements or method steps also include embodiments which “consist of” said recited members, elements or method steps. The singular forms “a”, “an”, and “the” include both singular and plural referents unless the context clearly dictates otherwise.

As used herein, relative terms, such as “left,” “right,” “front,” “back,” “top,” “bottom,” “over,” “under,” etc., are used for descriptive purposes and not necessarily for describing permanent relative positions. It is to be understood that such terms are interchangeable under appropriate circumstances and that the embodiment as described herein are capable of operation in other orientations than those illustrated or described herein unless the context clearly dictates otherwise.

Objects described herein as being “adjacent” to each other reflect a functional relationship between the described objects, that is, the term indicates the described objects must be adjacent in a way to perform a designated function which may be a direct (i.e. physical) or indirect (i.e. close to or near) contact, as appropriate for the context in which the phrase is used.

Objects described herein as being “connected” or “coupled” reflect a functional relationship between the described objects, that is, the terms indicate the described objects must be connected in a way to perform a designated function which may be a direct or indirect connection in an electrical or nonelectrical (i.e. physical) manner, as appropriate for the context in which the term is used.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, the term “about” is used to provide flexibility to a numerical value or range endpoint by providing that a given value may be “a little above” or “a little below” said value or endpoint, depending on the specific context. Unless otherwise stated, use of the term “about” in accordance with a specific number or numerical range should also be understood to provide support for such numerical terms or range without the term “about”. For example, the recitation of “about 30” should be construed as not only providing support for values a little above and a little below 30, but also for the actual numerical value of 30 as well.

The recitation of numerical ranges by endpoints includes all numbers and fractions subsumed within the respective ranges, as well as the recited endpoints. Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the disclosure described herein are capable of operation in other sequences than described or illustrated herein.

Reference in this specification may be made to devices, structures, systems, or methods that provide “improved” performance (e.g. increased or decreased results, depending on the context). It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

In the present description, technology is described by means of which the hybrid drying of industrial goods can be improved; i.e., by simultaneously exposing the goods to microwaves and an air circulation. Specifically, the herein disclosed technology may improve the thermal and/or electrical efficiency for the drying of wet and cold products such as raw materials having a high moisture content and low temperature.

Many industrial products are initially processed or stored in a wet, possibly outside environment but need to be dried for further processing or transportation. The technology of the present disclosure can be regarded as “generally applicable” drying technology in the sense that it can be readily applied for drying of a variety of raw material or product, provided that such material is suitable for drying by means of a combination of microwave and air circulation. The general applicability will be illustrated below with some exemplary application.

In an exemplary application, the drying of materials from the metal or mining industry can be considered, such as drying of granulated slag, sand or minerals, and so on. For this industry the drying efficiency is of particular importance to improve productivity. Specifically, the provision of a drying solution that requires little to no preparation, i.e., allows for immediate drying of the product, can significantly improve productivity. Because the product is frequently stored in bulk outside, the provision of a dedicated product preparation site would make the drying process undesirably complex. Accordingly, drying with MW is particularly advantageous since the product can be dried thoroughly from the inside-out, as compared to outside-in with conventional heating systems, which can allow for production of finer granulate/powder.

In another exemplary application, the drying of materials in the food or agricultural industry can be considered, such as fruit or other fresh harvest, or unprocessed materials such grass and wood clippings, and so on. For this industry the drying consistency is of particular importance to ensure quality of the product, specifically since too high temperature can damage or even destroy it. Accordingly, the temperature needs to be kept sufficiently low, but still high enough to ensure efficient drying. Accordingly, drying with MW is particularly advantageous since it allows for improved control of the heating parameters with faster response times if a temperature exceeds a specific threshold, as compared to difficult to control and slow to respond conventional heating systems.

Microwave drying in present drying systems is typically applied to trigger dielectric heating resulting in rapid energy coupling into the moisture leading to fast heating. Due to the varying dielectric nature of the products to be dried, such systems require a high amount of energy. To this extent, convective drying can be employed to support the microwave drying process. However, combining MW and convective drying requires the provision of additional energy, which decreases the overall energy efficiency of such systems. Moreover, any changes in the product or environment's conditions can highly impact the speed, efficiency, and thus economic viability of these systems.

The present disclosure relates to a system and methods for hybrid drying of industrial goods, which allow for a more energy efficient and faster of a variety of wet products. This in turn can achieve a more economic drying solutions suitable for a wide range of industrial applications. Specifically, the present system may reduce or altogether circumvent existent delays in the for start-up (start/stop) and requires little to no product preparation. This is particularly beneficial for batchwise drying because it allows for the drying to be safely interrupted for filling up the supply/storage tank between drying sessions, without losing drying efficiency, specifically compared to drying system that need to reach a specific operating temperature and as a result need to remain continuously activated. Further, the present system may allow for improved monitoring of the drying temperature and controlling of the product flow such that it can be applied for the drying of delicate products, for example by allowing immediate termination when a threshold max temperature is exceeded.

Additionally, the improved energy efficiency can be combined with various “green” energy sources to achieve more an eco-friendlier drying solution. Specifically, the present system can be more easily integrated and synchronised into smaller electric grid, preferably smart grids providing energy obtained from solar and wind power. To clarify, because of the reduced start-up times, the drying can be synchronised with the green energy generation, e.g., as soon as the environmental conditions allow for generation of wind/solar energy the drying can be started for operation during high energy peaks (low costs) and avoid low energy peak (high cost).

Unless otherwise defined, all terms used in describing the technology, including technical and scientific terms, have the meaning as commonly understood by one of ordinary skill in the art to which this disclosure belongs. By means of further guidance, definitions for the terms used in the description are included to better appreciate the teaching of the present disclosure. The terms or definitions used herein are provided solely to aid in the understanding of the technology.

As used herein, “moisture content” refers to the amount of water contained in the product which is commonly expressed as a percentage of the weight of a product.

As used herein, a “wet product” refers to a product to be dried, whereby the moisture level of said product is higher than desired. The wet product may have a moisture content of at least 15%, preferably at least 17.5%, more preferably at least 20%, even more preferably at least 22.5%, even more preferably at least 25% or more. The skilled person understand that the moisture content of a provided wet product depends on the type of raw material or product and its processing. Nonetheless, for very high moisture content, such as 50% or more, it may be advantageous to drain the product of excess water content before proceeding with the drying.

Accordingly, “dried product” then refers to a product that has been dried such that the moisture level of said product is at the desired value. The skilled person understand that the desired moisture content of a dry product depends on the type of raw material or product and its application. The dried product may have a moisture content of at most 15%, preferably at most 12.5%, more preferably at most 10%, even more preferably at most 7.5%, even more preferably at most 5%, even more preferably at most 2.5% or less.

As used herein, “humidity” refers to the concentration of water vapour present in the air, which is commonly expressed as a “relative humidity” based on temperature and water content.

As used herein, “drying air” refers to air that contacts or will contact a product to be dried, whether wet or partially dried. The drying air will increase the temperature of the contacted product and reduce its moisture content, thereby reducing its own temperature and increasing its humidity. As such, the warm air advantageously has a higher temperature than the provided product. The temperature of the warm drying air in a convective dryer may be between at least 30.0° C. to at most 160.0° C., preferably 35.0° C. to 150.0° C., more preferably 40.0° C. to 140.0° C., even more preferably 45.0°° C. to 130.0° C., even more preferably 50.0°° C. to 120.0° C., even more preferably 60.0° C. to 110.0° C., even more preferably 70.0° C. to 100.0° C., for example 80.0° C. or 90.0° C. The skilled person understands that a higher air temperature allows for faster and more efficient heating of the product, but the maximum temperature should be adjusted to the product's sensitivity.

Additionally, temperature of the air circulated inside the MW system will preferably be kept below 100° C. to reduce the dew point. For MW drying the air temperature is generally of lesser importance than its capacity to take up evaporative moisture from the product, i.e., the maximum moisture carrying capacity, which is defined by the air temperature and humidity. Specifically, for microwaves the evaporative drying effect can be made more efficient by providing dry air to remove moisture at the surface of the product.

To clarify, the because of the MW drying process, any moisture present inside the product is effectively “pushed” towards the surface and hence removal of said surface moisture with drying air can increase the drying speed of the product within the MW system.

Accordingly, “spent air” then refers to air that has contacted a product, whether wet or partially dried, and as a result has taken up excess moisture from said product and possibly lowered its temperature by warming up the product. As such, the spent air may have a lower temperature and/or increased relative humidity compared to the circulated air. The temperature of the spent air may be between at least 10.0° C. to at most 100.0° C., preferably 15.0° C. to 90.0° C., more preferably 20.0° C. to 80.0° C., even more preferably 25.0°° C. to 70.0° C., even more preferably 30.0°° C. to 60.0° C., for example 40.0° C. or 50.0°. Nonetheless, the skilled person understands that temperature and humidity of the spent air depends on the initial temperature and humidity of the air provided to the relevant device as well as the temperature and moisture content of the product. Also the ambient conditions of the system and environment may affect the temperature and humidity of the provided and spent air.

As used herein, “hybrid drying” refers to a drying process in which a product is simultaneously exposed to microwaves (MW) and an air circulation. The person skilled in the art understands that, depending on the industrial application of the hybrid drying and the conditions of the wet product, e.g., temperature and humidity content, the proportion of convective and MW drying can be opportunely tuned.

As used herein, “air circulation drying” refers to a drying process in which a product is exposed to an air circulation in a device. The air can have different temperatures and different relative humidity depending on its purpose. For example, the air circulation may comprise a dry and preferably sufficiently hot fluid to supply the heat necessary for evaporation of the moisture within the wet product, as well as remove the water vapour from its surface. Specifically, as used herein “fluids” typically refers to air. However, it is understood that for particular embodiments a specific gas may be employed or a combination of such gas with air. The person skilled in the art understands that, depending on the industrial application of the hybrid drying system, different configuration can be employed to dry the product by changing the air temperature and relative humidity. Exemplary configurations will be described throughout the present disclosure.

As used herein, “microwave (MW) drying” concerns the drying of a product by means of microwave technology as is known in the art. A microwave drying system as known in the art may comprise a microwave generator for generating microwaves and a microwave emission source for exposing the product to the microwaves generated by the microwave generator. The microwave drying system may comprise various components for guiding the generated microwaves from the microwave generator to the microwave emission source.

During MW drying the temperature of the dried material largely depends on the balance between the energy generated by the water dipoles in the microwave field and the energy absorbed by water molecules evaporated from the surface of the material. In an exemplary embodiment MW drying can be employed by generating microwaves refers to at an operating frequency in the ranges 900 MHz and 950 MHz and between 2400 MHz and 2500 MHz, having a centre resonating frequencies equal to 915 MHZ and 2450 MHz, respectively. Nonetheless, the person skilled in the art understands that various other microwave frequencies can be employed and the herein described microwave drying is not limited to a specific frequency thereof.

The “drying efficiency” is defined in accordance with the drying efficiency equation, i.e.,

$$Drying efficiency = \frac{Theoretical energy required}{Electric energy used} ,$$

which defines the ratio between the theoretical required energy to dry a product and the actual energy consumption needed to effectively obtain the dried product.

Furthermore, the “drying efficiency percentage” is determined according to the following formula,

$$Drying efficiency [ \% ] = \frac{{H}_{2} O evaporated [ \frac{kg}{h} ] * 2676 [ \frac{kJ}{kg} ]}{Electric power [ kW ] * 3600 [ \frac{s}{h} ]} ,$$

which refers to the theoretical energy required to create 1.0 kg of steam of 100° C. (2676.0 KJ/kg) divided by the electric energy used to evaporate 1 kg of water in the microwave drying process.

As used herein, “airflow” or “air circulation” refers to a flow of fluid comprising a combination of air and/or water, and is defined as the measurement of the amount of fluid per unit of time flowing through a particular device expressed in kg/h throughout this disclosure. The direction of airflow may be guided using techniques and devices in the art such as air inlets/outlets, or it may even be controlled using devices that create a current of air, such as vents, fans or the like. The airflow may be unidirectional or laminar, for example, flowing from an air inlet to an air outlet. The airflow may be turbulent, for example, by swirling over a specific area until it is removed by an air outlet.

As used herein, the heat pump system refers to a device as known in the art, which is configured to transfer thermal energy from a low temperature airflow to a higher temperature airflow, substantially transferring the heat in the opposite direction in which heat transfer would take place, without the need for external power.

The efficiency of a heat pump system is expressed as coefficient of performance (CoP), i.e.,

$$CoP = \frac{Heat generated by heat pump}{Energy used by heat pump} .$$

As used herein, the volumetric “flow rate” refers to the speed at which a substance such as the product or fluid moves through the drying system or any components thereof. The flowrate may be expressed in kg/h, which indicates how much weight of said substance is moved per hour. Specifically, the product flowrate refers to the portion of the dried product (in kg/h), the water flowrate refers to the portion of the available moisture within the wet product, and the total flowrate accordingly provides a linear combination between said product and water flowrates.

An overview of various aspects of the technology of the present disclosure is given hereinbelow, after which specific embodiments will be described in more detail. This overview is meant to aid the reader in understanding the technological concepts more quickly, but it is not meant to identify the most important or essential features thereof, nor is it meant to limit the scope of the present disclosure, which is limited only by the claims. When describing specific embodiments, reference is made to the accompanying drawings, which are provided solely to aid in the understanding of the described embodiment.

An aspect of the present disclosure relates to a method for energy-efficient hybrid drying of industrial goods such as raw materials, said drying method comprising the steps:
providing a wet product;
preconditioning the product by successively exposing it to a first air circulation circulated through a first air circulation device, and a second air circulation circulated through a second air circulation device;
hybrid drying the product by simultaneously exposing it to microwaves generated by a microwave drying device and air circulated through the microwave drying device;
whereby the second air circulation circulated in the second air circulation device comprises the spent air from the first air circulation device, that is warmed up and dehumidified using a heat pump system such that the second air circulated in the second air circulation device has a lower relative humidity and a higher temperature than the first air circulation circulated in the first air circulation device;
whereby the first air circulation circulated in the first air circulation device comprises the spent air from the microwave drying device, that is warmed up and humidified in the microwave drying device such that the air circulated in the first air circulation device has a higher relative humidity and a higher temperature than the third air circulation circulated through the microwave drying device.

The method proposes a specific drying process by which a product is successively exposed to a number of independent air circulations that have a different temperature and a different humidity. In this way, a wet and optionally cold product can be preconditioned towards a warm and surface dry state that allows for a faster and more energy efficient evaporative drying by microwaves. The successive steps will be discussed in more detail.

During the first preconditioning step, the wet and optionally wet product is exposed to a relative humid and advantageously warm air in a first air circulation device. Humid air has a higher heat transfer rate when contacting a wet and cold product in comparison with dehumidified; therefore, a wet and cold product can be warmed up efficiently compared to using dehumidified. At the same time, the circulated first air becomes colder but remains humid still. Cold and humid air is particularly suitable for a heat pump system as will be discussed later.

During the second preconditioning step, the partially preconditioned product (that was warmed up) is exposed to a dehumidified and advantageously warm air in a second air circulation device. Dehumidified air can take up more moisture; therefore, a wet product can be more efficiently surface dried compared to humid air. At the same time, the circulated second air becomes colder and humid. As a result of the preconditioning, the previously cold and wet product becomes a warmed up and surface dried product. This preconditioned state is particular efficient for evaporative drying by means of microwaves.

Next the preconditioned product (that was warmed up and surface dried) can be dried from the inside-out to the desired moisture content by means of a microwave drying. To elaborate, because of the preconditioning steps the surface of the preconditioned product will sufficiently dry and most moisture will be trapped within the bulk of the product. The microwaves can more easily penetrate the product and start heating from within which will cause transfer of moisture to the surface of the product to allow for evaporative drying. Additionally, to maintain high drying efficiency an additional air circulation can be provided into the microwave cavity to take up any moisture on the product's surface during the microwave drying process. Advantageously the air in the microwave cavity is warmed using waste heat from the microwave drying device or any components to increase its maximum moisture carrying capacity, which can increase the energy efficiency of the method even further still. Optionally, captured spent air from the preconditioning steps can also be repurposed for the microwave cavity provided that is sufficiently dry; hence depending on the product's initial moisture content and available air humidity.

As used herein, “preconditioning” refers to a process in which a product is conditioned into a state that improve the drying efficiency of microwave drying. Advantageously, a wet product is preconditioned to obtain a surface dried product. Advantageously, a cold product is preconditioned to obtain a warmed-up product. Preferably, a wet and cold product is preconditioned to obtain a surface dried and warmed-up product. The drying efficiency when exposing the preconditioned product to microwaves will therefore be improved compared to the same product in its provided state.

The air circulations are implemented in a way that the difference in air temperature and humidity for one air circulation is efficiently realised by capturing and diverting spent air from another air circulation. More specifically, air circulated in the microwave drying system can absorb evaporative moisture from the product surface and warm up from waste heat. The spent air will therefore have a higher relative humidity and higher temperature than the air circulated in the microwave drying system. The spent air from the microwave drying system (that was humidified and warmed up) can be fed into a first air circulation device. As discussed earlier, humid air has a higher heat transfer rate when contacting a wet and cold product in comparison with dehumidified air; therefore, it can more efficiently warm up a cold and wet product. The spent air will therefore have an even higher relative humidity but lower temperature than the air circulated in circulation device (that is, the spent air from the microwave drying system). The spent air from the first air circulation device can be passed through a heat pump system. Since the spent air is very humid, the heat pump can function more efficiently while dehumidifying the provided air. The air processed by the heat pump system (that is, the spent air from the first air circulation device) can be fed into a second air circulation device. As discussed earlier, dehumidified air can take up more moisture; therefore, it can more efficiently surface dry a warmed up but still product. In this way, an efficient air circulation is implemented to warm up and surface dry a wet and cold product before applying microwaves to dry it.

In an embodiment the first air circulation comprises the spent air. Accordingly, the method may comprise the step of capturing and guiding the spent air to the wet product such that it can be circulated as the first air circulation.

In an embodiment the first air circulation is warmed up by a heating element and/or with heat from the heat pump system.

In an embodiment the second air circulation comprises the spent air which is warmed up and dried by means of a heat pump system. Accordingly, the method may comprise the step of capturing and guiding the spent air to the heat pump system such that can be processed therewith, and further guiding the processed air from the heat pump system to the partially preconditioned product such that it can be circulated as the second air circulation.

In an embodiment the third air circulation comprises air which is warmed up using waste heat from the microwave drying device. Accordingly, the method may comprise the step of providing air and guiding said air through the microwave drying device or a component thereof such that it can be warmed up with its waste heat.

In an embodiment the third air circulation comprises outside air, i.e., air provided from the exterior of the system, which advantageously has been warmed up with the waste heat of the microwave drying device.

Accordingly, the method may comprise the step of providing outside air and guiding said air through the microwave drying device and/or a component thereof such that it can be warmed with its waste heat.

The components may for example include any electrical or cooling components. Preferably the third air circulation comprises at least 20% vol. of outside air, preferably 30% vol., more preferably 40% vol., even more preferably 50% vol. or more. Alternatively, the third air circulation may comprise outside air only, i.e., without mixing of captured spent air, in which case the third air circulation comprises 100% vol. of outside air.

In an embodiment the third air circulation comprises the spent air from the second air circulation) which has been warmed with the waste heat of the microwave drying device. Accordingly, the method may comprise the step of capturing and guiding the spent air through the microwave drying device or a component thereof such that it can be warmed with its waste heat. Preferably the third air circulation comprises at least 20% vol. of the spent air from the second air circulation, preferably 30% vol., more preferably 40% vol., even more preferably 50% vol. or more. Alternatively, the third air circulation may comprise spent air only, i.e., without mixing of outside air, in which case the third air circulation comprises 100% vol. of outside air.

In an embodiment the third air circulation is warmed and dried during the microwave drying such that the captured spent air has a higher temperature than the provided third air circulation. This can make the warmed third air circulation even more suitable for use as first air circulation.

In an embodiment the spent air from the first air circulation is split into at least two air portions in the heat pump system, including a first air portion which passes through an evaporator, and a second air portion which bypasses said evaporator and is mixed with the first air portion having passed through the evaporator to obtain mixed air; and whereby said mixed air passes through a condenser and is warmed obtain the second air circulation. Preferably the first air portion comprises at least 50% vol. of the captured spent air, preferably 60% vol., more preferably 70% vol., even more preferably 80% vol; even more preferably still 90% vol.; even more preferably still 100% vol.

In an embodiment the mixed air is warmed by means of a heating element, preferably an electric heater. This can make the air processed by the heat pump system even more suitable for use as second air circulation while increasing the energy efficiency of the method. The heating element can advantageously be powered using energy generated by the system or a green power source such as solar panels or wind turbines.

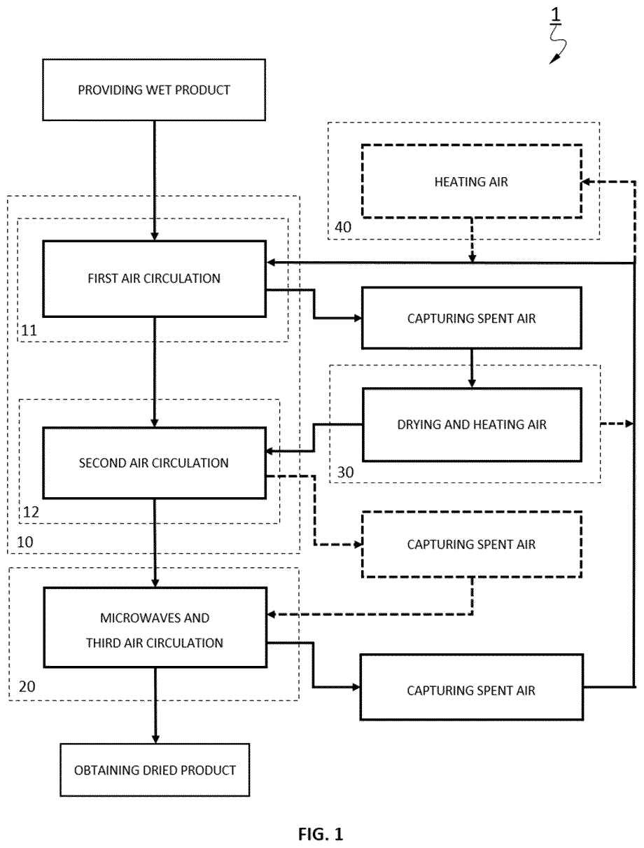

The present drying method will be discussed in more detail with reference to FIG. 1, which is a block diagram illustrating the steps of said method according to a general embodiment. As illustrated, firstly a wet product is provided, which is to be dried by the present method. The wet product has a moisture content which is higher than desired, and typically a low temperature which typically might correspond to the ambient temperature.

As initially described above, the wet product will be subjected to a sequence of air circulations in which said product is incrementally preconditioned in order to improve the drying efficiency of the microwaves.

To clarify, if the dielectric loss factor of the product is high enough, the limiting factor in the drying process is not the speed of the energy transfer but rather the speed of mass transfer. As long as the absorbed microwave power is higher than the energy lost due to evaporation, the product can continue to heat up eventually reaching the maximum process temperature.

Accordingly, FIG. 1 shows that in a first preconditioning step the provided wet product can be subjected to a first air circulation aimed at pre-warming the product by raising its temperature. As will be discussed in more detail below, the first preconditioning step can be performed by circulating an advantageously warm and humid air comprising at least a portion of spent air from microwave drying device 20, which advantageously has a higher temperature than the wet product. The air used to prewarm the wet product can be captured as spent air, which has been cooled during the first preconditioning step. The air is (partially) saturated when the relative humidity increases to approximately 100%, although this may not be the case in all applications. For example, the relative humidity can increase when the temperature decreases and/or absolute humidity increases, for example, by taking the moisture from the product. Optionally, the circulated air can be further warmed by means of heating element 40 to the desired temperature, for example if the air temperature is too low for the first preconditioning step-the dashed line indicates that said additional heating of circulated air is optional.

The first preconditioning step is particularly advantageous as it allows for increasing the product's overall temperature without or minimally reducing the product's moisture level, which is beneficial for the microwave drying process. Additionally, this can allow for keeping the product parameters stable across different changes in ambient conditions (e.g. seasons, weather conditions), geography and day/night cycles such that the expected drying efficiency and times can be kept more or less stable.

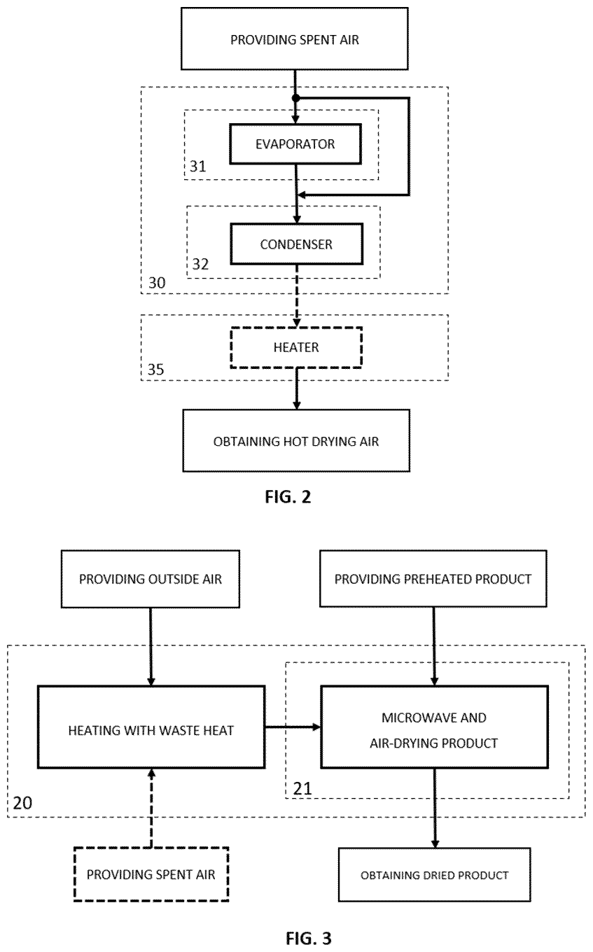

In a following step, the captured spent air from the first air circulation can be warmed and advantageously dried by means of heat pump system 30 comprising evaporator 31 and condenser 32, configured to extract latent heat from the spent air and remove excess moisture. The configuration of heat pump system 30 is discussed further with reference to FIG. 2, which illustrates how the captured spent air can be split into at least two air portions in said system 30. Specifically, the spent air is split into a first air portion which can be passed through evaporator 31 and a second air portion which can bypass said evaporator 31. In an embodiment heat pump system 30 may comprise a bypass circuit having a bypass tube for connecting an intake side of the evaporator 31 with a portion that extends from the outlet of said evaporator 31, but other configurations are also possible.

Once the first air portion has passed through evaporator 31, the processed first air portion can be mixed with the unprocessed second air portion to obtain mixed air, which can be passed through condenser 32 and advantageously be warmed therewith. In an embodiment the outlet of evaporator 31 may connect with a bypass tube connected to an intake side of said evaporator 31, whereby the connection of said evaporator outlet and said bypass tube connect to an inlet of condenser 32. As a result of the above, the captured spent air from the first air circulation can be deprived of excess moisture, as well warmed up using the extracted thermal energy to obtain air suitable for further drying of the product. Optionally, the air can be further warmed by means of heating element 35 to the desired temperature, for example if the air temperature is too low for the second preconditioning step-the dashed line indicates that said additional heating of circulated air is optional.

Continuing with the method of FIG. 1, it is further shown that the partially preconditioned product can be subjected to a second air circulation aimed at further preconditioning the product by raising its temperature even more and advantageously removing its moisture from the surface. As discussed above, the second air circulation is performed by circulating the spent air from the first air circulation which has been warmed and advantageously dehumidified by means of heat pump system 30. Advantageously the preconditioned product will have a very low surface humidity which is beneficial for the microwave drying process as described below. Optionally, the air used to precondition the product can be captured as spent air, which has been partially cooled by contacting said product during the second preconditioning step—the dashed line indicates that the said capturing of spent air is optional.

Continuing further still, a combination of air circulation and microwave (MW) drying can be used to efficiently dry the preconditioned product to the desired moisture content, preferably to fully dry the product. Due to the product being properly preconditioned the overall microwave drying efficiency of the system can be increased. Additionally, circulated air can be circulated through MW drying device 20, specifically in the microwave cavity. However, the function of the third circulated air in the MW drying device is not transferring (a significant amount) of energy to the product like in conventional hot air dryers, but to take up any moisture being pushed to the product's surface by the microwave heating process such that the high drying efficiency can be maintained by keeping the product surface dry. As such, it is advantageous for the third circulated air to be sufficiently dry/low in humidity.

The configuration of the MW drying device 20 is discussed further with reference to FIG. 3 which illustrates how the MW drying device 20 can be provided with outside air which can be preconditioned using waste heat from the microwave drying process and/or any electrical components of the MW drying device, such as the circuit, generator, power supply, and so on. For the latter the outside air can be first guided through the housing of the MW drying device, such that it can heat up while simultaneously cooling said electrical components. Accordingly, the warmed air can be guided into the microwave cavity 21 of the MW drying device to act as a third air circulation. Optionally, the MW drying device can additionally be provided with spent air from the second preheating step, which can be warmed with waste heat from the MW drying device-the dashed line indicates that said provision of spent air is optional. The spent air can be warmed in the same way as the outside air described above. As such various combinations are possible within the scope of the illustrated method; specifically, the provision of outside air, the provision of spent air, and the provision of both outside and spent air which are mixed prior to entering the microwave cavity.

Referring back to FIG. 1, it is shown that once the preconditioned product reaches microwave cavity 21 of the MW drying device 20, it can be subjected to microwaves with the appropriate configuration to reach the desired moisture level. Additionally, providing an air current over the product increases evaporation rates and allows a higher input power without increasing the drying temperature or when input power is maintained, a lower drying temperature without lowering evaporation speed. Warm air has a higher maximum moisture carrying capacity than cold air when both have the same absolute humidity. Accordingly, warm air can allow for faster evaporation of water in the product's surface. However, the humidity of the provided warm air will typically be of greater importance than the temperature since saturated warm air cannot take up moisture as well as relatively dry cold air. Another way to lower vapor pressure of water is to decrease the pressure: vacuum microwave drying can operate at even lower temperatures.

The provision of air with a high moisture carrying capacity in the MW cavity can therefore shorten the required drying times and/or lower the product's drying temperature. Both are beneficial to the energy efficiency of the dryer, as shorter drying times can enable the use of smaller, more energy efficient components and hence less area for energy waste, while lower drying temperatures reduce heat loss due to a lower AT with the environment and less energy is wasted in the form of a warm product exiting the dryer. Decreased process temperature and time have a beneficial influence on the quality of many products which is in some cases more important even than the cost of drying.

A first overview of various components of the system according to the present disclosure is given hereinbelow, after which specific embodiments will be described in more detail. It is understood that the system can be configured for performing the method of the present disclosure and any embodiments thereof. Hence, any embodiments of the above-described method also form embodiments of the below-described system, and vice versa.

Another aspect of the present disclosure relates to a system for energy-efficient hybrid drying of industrial goods such as raw materials, the hybrid drying system comprising:
a preconditioning system comprising a first air circulation device configured for exposing a product to a first air circulation, and a second air circulation device configured for exposing the product to a second air circulation;
a heat pump system configured for receiving spent air from the first air circulation device, warming and dehumidifying said spent air, and feeding it to the second air circulation device such that the air of the second air circulation has a lower relative humidity and a higher temperature than the air of the of the first air circulation;
a microwave drying system comprising a microwave generator for generating microwaves, a microwave emission source configured for exposing the product to the generated microwaves, and a third air circulation device configured for simultaneously exposing the product to a third air circulation;
an air circulation means configured to receive spent air from the microwave drying system, which is warmed up and humidified in the microwave drying device, and feeding it to the first air circulation device such that the first air circulation has a higher relative humidity and a higher temperature than the third air circulation; and,
a conveyor means configured to convey a product successively through the first air circulation device, the second air circulation device and the microwave drying device.

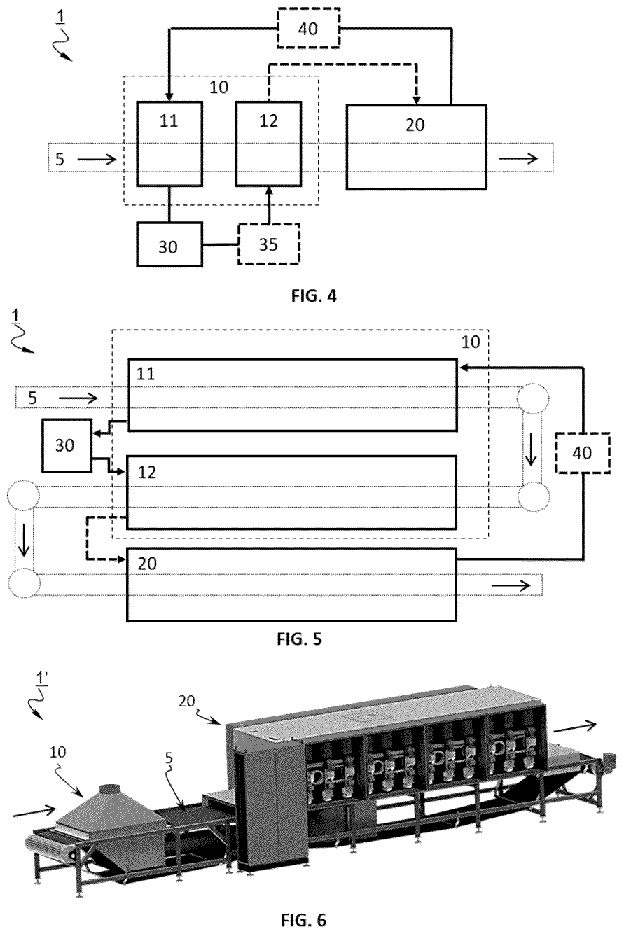

An embodiment of the present drying system 1 will be discussed in with reference to FIG. 4, which is a block chart representing the components of the hybrid drying system 1 arranged linearly. Specifically, the system 1 comprises a linear conveyor device 5 onto which a wet product can be provided, which runs through the at least three successively arranged drying components of the system. More specifically, the wet product is first transported through a first air circulation device 11, which forms the first part of the preconditioning system 10, in which the product is warmed to obtain a partially preconditioned product. Next, said partially preconditioned product is transported through a second air circulation device 12, which forms the first part of the preconditioning system 10, in which the product is surface dried to obtain a preconditioned product. Lastly, said preconditioned product is transported through a MW drying device 30 wherein it is dried and dehydrated by means of a combination of microwave and air circulation to obtain a dried product.

Additionally, FIG. 4 illustrates the flow of drying air throughout the components of the hybrid drying system 1. Specifically, the spent air from the MW drying device 20 is captured and supplied to the first air circulation device 11. Optionally, the drying air can be warmed by means of heating element 40 to the desired temperature. Further, the spent air from the first air circulation device 11 is captured and supplied to a heat pump system 20 which processes said spent air by drying and heating it such that it can be supplied to the second air circulation device 12. Optionally, the spent air from the second air circulation device 12 can be captured and supplied to the MW drying device-the dashed line indicates that said capturing of spent air is optional. Additionally or alternatively, outside air can be provided to the MW drying device 20 in which it can be warmed with waste heat from the microwave drying process and/or its electrical components.

In an embodiment the first air circulation circulated in the first air circulation device comprises spent air from the MW drying device. Accordingly, the system may comprise means configured for capturing the spent air from the MW drying device and guiding said spent air to the first air circulation device such that it can be circulated as the first air circulation.

In an embodiment the second air circulation circulated in the second air circulation device comprises the spent air from the first air circulation device, which is warmed and dried by means of the heat pump system. Accordingly, the system may comprise means configured for capturing the spent air from the first air circulation device and guiding said spent air to the heat pump system, and further guiding the air processed by means of the heat pump system to the second air circulation device such that it can be circulated as the second air circulation.

In an embodiment the heat pump system may comprise an evaporator and a condenser, whereby the spent air from the first air circulation device can be split into at least two air portions, including a first air portion which is passed through the evaporator, and a second air portion which can bypass said evaporator and can be mixed with the first air portion having passed through the evaporator to obtain mixed air; and whereby said mixed air can be passed through a condenser and warmed to obtain the second air circulation.

In an embodiment the system may comprise a heating element configured to further heat the air processed by means of the heat pump system to obtain warm air. Specifically, the heating element may be beneficial for applications wherein the processed air is too cold for the intended drying purposes for the second air circulation device. The heating element may be part of or be comprised in the same housing as the heat pump system, or it may be positioned externally between the heat pump system and the second air circulation device.

In an embodiment the heating element for the heat pump may be the same heating element as for the microwave drying device, or at least connected thereto. Advantageously the heating element is warmed or powered using waste heat or captured energy from the heat pump system. This can reduce the complexity of the system.

In an embodiment the third air circulation circulated in the MW drying device comprises air which is warmed using waste heat from the MW drying device. Accordingly, the system may comprise means configured for providing air and guiding said air through the MW drying device or a component thereof and heating it with the waste heat.

In an embodiment the third air circulation circulated in the MW drying device comprises air which has been warmed using waste heat from the MW drying device. Accordingly, the system may comprise means configured for providing air and guiding said air through the MW drying device or a component thereof and heating it with the waste heat.

In an embodiment the third air circulation circulated in the MW drying device comprises outside air which has been warmed with the waste heat of the MW drying device. Accordingly, the system may comprise means configured for providing outside air and guiding said air through the MW drying device or a component thereof and heating it with the waste heat. Preferably the third air circulation comprises at least 20% vol. of outside air, preferably 45% vol., more preferably 50% vol., even more preferably 55% vol.

In an embodiment the third air circulation circulated in the MW drying device comprises the spent air from the second air circulation device which has been warmed with the waste heat of the MW drying device. Accordingly, the system may comprise means configured for capturing and guiding said spent air and guiding said air through the MW drying device or a component thereof and heating it with the waste heat. Preferably the third air circulation comprises at least 20% vol. of spent air, preferably 45% vol., more preferably 50% vol., even more preferably 55% vol.

In an embodiment the system may comprise a heating element configured to heat or preheat outside air and/or spent air to obtain warm air. Specifically, the heating element may be beneficial for applications wherein the provided air is too cold for the drying purposes, for example due to cold ambient conditions at night or cold weather. The heating element may be part of or be comprised in the same housing as the microwave system, or it may be positioned externally and provide warmed air to the microwave system.

In an embodiment the conveyor device may comprise any conveyor device such as a conveyor belt and/or a screw conveyor to enable efficient transportation of the product throughout the hybrid drying system.

It is clear that the conveyor device may include other transportation devices that are suitable for transporting the product, but a conveyor belt and/or a screw conveyor are considered most suitable for transporting of industrial goods such as raw materials. The screw conveyor has the additional advantage of mixing product while conveying.

In an embodiment the product can be mixed during conveying such that the product's moisture and/or provided heat is distributed throughout the bulk product. The mixing may be continuous during the entire system or any components thereof, or intermittent, for example between the first and second air circulation device and/or between the second air circulation device and the microwave drying device. Providing an intermittent mixing device has the advantage of being mechanically less complex to realise.

In an embodiment the drying system may comprise means for supplying power to the components of the system. Typically, the system may comprise means for connecting the system to external power source, such as a power cable connected to an electrical grid. In a preferred embodiment the system may comprise one or more solar panels or other sources of renewable energy. This may further increase the energy efficiency of the drying system, in addition to decreasing its environmental impact.

Another embodiment of present drying system will be discussed in with reference to FIG. 5, which is a block chart representing the components of the hybrid drying system 1 stacked on top of each other. Compared to the above discussed embodiment of FIG. 4, the present embodiment allows for more efficient space management and control of the process flow. To clarify, each drying component of the system 1 (specifically, the first air circulation device 11, the second air circulation device 12 and the microwave system 20) can be arranged on a different level, advantageously going downwards such that gravity can be used to push part of the product from level to the other. This also allows more space in between or parallel to the system for the non-drying components, such as the heat pump system 30, heating elements, power sources, etc. Accordingly, such a system configuration is particularly advantageous on sites where there is limited space for construction of the drying system. The conveyor device 5 may run continuously from one level to another, or each level may be provided with a separate conveyor device 5. Additionally, the product can be more easily mixed when passing between levels to spread the internal temperature and moisture realised through the convective drying means, for example between the first and second air circulation device. It is understood that any embodiment described above with reference to FIG. 4 can also be applied in the embodiment of FIG. 5 unless otherwise specified. Additionally, the skilled person understands that a combination of the embodiments illustrated in FIG. 4 and FIG. 5 is also possible, for example whereby the second and first air circulation device are arranged on the same level and the MW drying device 20 is arranged in another level. For example, FIG. 6 is an illustration of a part of the hybrid drying system 1 whereby the first air circulation device 11 and the MW drying device 20 are arranged on the same level, but the second air circulation device is on another level (not shown on the present illustration).

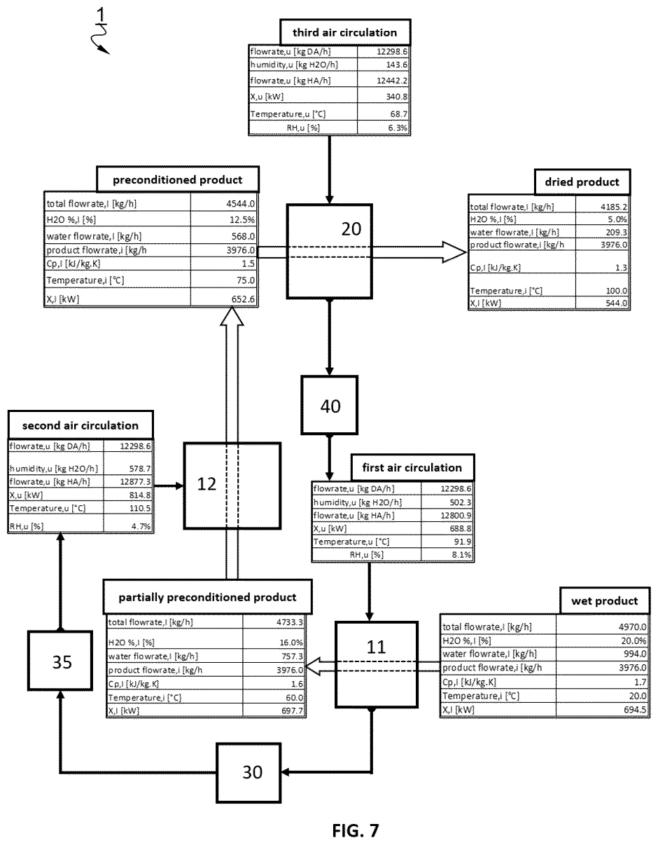

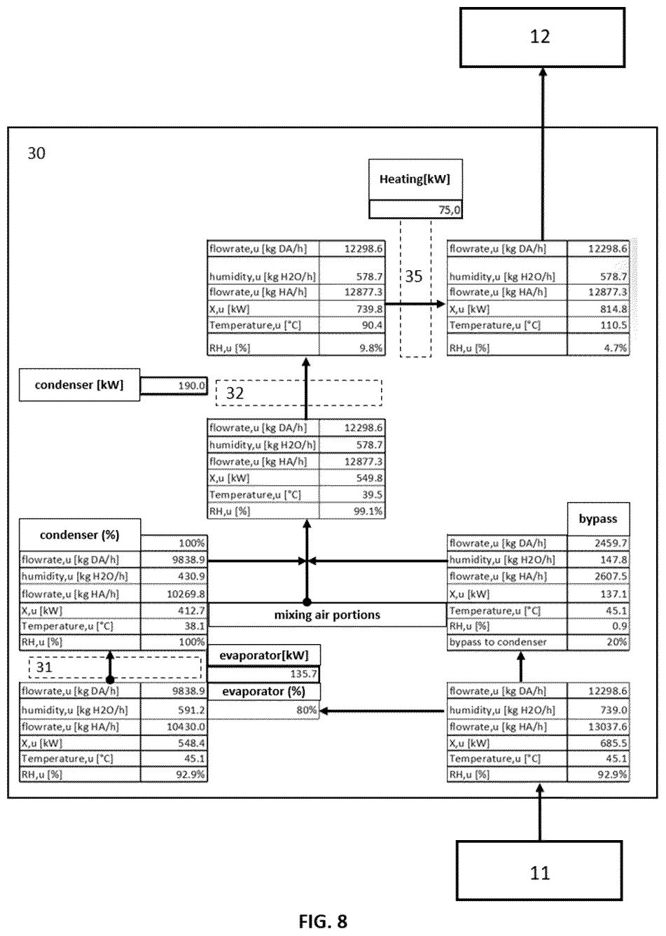

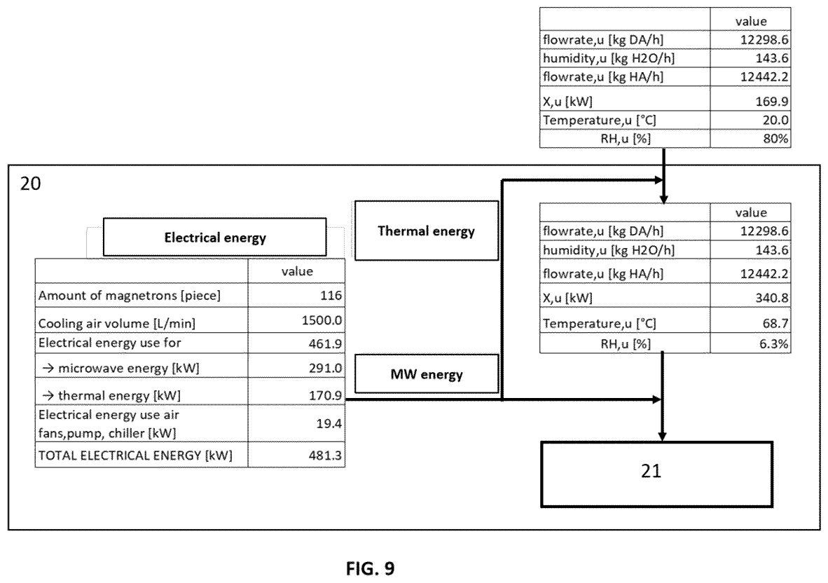

To better illustrate the advantages and features of the present disclosure hereinbelow a number of theoretical energy calculations will be discussed with reference to FIGS. 7 to 9. Specifically, FIG. 7 presents a flowchart related to the product flow as is passes through the hybrid drying system of the present disclosure. FIG. 8 presents a flowchart related to the airflow as is passes through heat pump system 30 of the present disclosure. FIG. 9 presents a flowchart related to the airflow as is passes through MW drying device 20 of the present disclosure. However, the skilled person understands that these theoretical calculations represent hypothetical situations and for real-life applications the values may vary greatly. Hence, the scope of the present disclosure is by no means limited to the illustrative examples described below, which serve only to illustrate the feasibility of the herein disclosed method and system.

Starting with FIG. 7, an exemplary incoming wet product having ambient temperature (20° C.) and a high moisture content (20% wt. vol) may be provided to the incoming product flow. The incoming wet product may have total flowrate of 4970 kg/h, which consists of a water flowrate of 994.0 kg/h and a product flowrate of 3976 kg/h. These values will result in an enthalpy value of 694.5kW.

As previously discussed, the wet product can be exposed to a first air circulation (91.9° C.) having a low relative humidity (8.1%) at a flowrate of 12800.9 kg HA/h. Optionally the first air circulation may be preconditioned with a heating element operating at 20 KW to the indicated temperature. As a result of the first preconditioning step with the first air circulation, a partially preconditioned product may be obtained which is advantageously partially dried. Accordingly, the partially preconditioned product may have an increased temperature (60.0° C.) and reduced moisture (16% wt. vol). Also, the total flowrate can be reduced to 4733.3 kg/h due to a reduction of the water flowrate of 757.3 kg/h while maintaining the same product flowrate of 3976 kg/h. These values will result in a reduced enthalpy value of 697.7 kW.

Next, the partially preconditioned product can be exposed to a second air circulation (110.5° C.) having a low relative humidity (4.7%) at a total flowrate of 12877.3 kg HA/h, which corresponds with a dry air flow rate of 12298.6 kg/h and a water vapor flow rate of 578.7 kg/h. The processing of the spent first air circulation to the second air circulation will be discussed further below with reference to FIG. 8. As a result of the second preconditioning step with the second air circulation, a preconditioned product may be obtained which is advantageously further dried still. Accordingly, the preconditioned product may have a still increased temperature (75° C.) and still reduced moisture (12.5% wt. vol). Also, the total flowrate can be reduced to 4544 kg/h due to a reduction of the water flowrate of 568 kg/h while maintaining the same product flowrate of 3976 kg/h. These values will result in a reduced enthalpy value of 652.6 kW.

Further still, the preconditioned product can undergo a hybrid drying by exposing it to MW while circulating a third air circulation (68.7° C.) with a very low relative humidity (6.3%) at a total flowrate of 12442.2 kg HA/h. The relevant MW parameters will be discussed further below with reference to FIG. 9. As a result of the hybrid drying, a dried product may be obtained with the desired moisture level. Accordingly, the dried product may have a high temperature (100° C.). The moisture level in the present example is 5%, but it is understood that this value may be adjusted accordingly. Also, the total flowrate can be reduced to 4185.2 kg/h due to a reduction of the water flowrate of 209.3 kg/h while maintaining the same product flowrate of 3976 kg/h as the provided product, indicating the same speed of product transfer throughout the system. These values will result in a reduced enthalpy value of 544 kW.

Continuing with FIG. 8, it is shown how the spent air derived from the first air circulation used in FIG. 7, may be processed and warmed by means of heat pump system 30 and heating element 35.

Specifically, as a result of the first preconditioning step, said spent air has lower temperature (45.1°° C.) and higher relative humidity (92.9%) as compared to the first air circulation.

As previously discussed, the spent air may be split into two air portions. In the present example the air is split (80/20), which means that the 80% of the captured air forms the first air portion is passed through evaporator 31 configured to capture the latent heat from the first airflow portion, whereas the remaining 20% forms the second air portion which is guided to bypass said evaporator 31 and be mixed with the first air portion before entering condenser 32. Advantageously, this enables the method to split the air in at least to airflow portions and to enable latent heat recovery from the first airflow portion to be recovered and transferred effectively to the mixed air flow.

Focusing first on the first airflow, the evaporator will capture the thermal energy from the first air portion such that the processed air will have its temperature reduced (38.1° C.) and the relative humidity increased (100%). Afterwards this processed air will be mixed to obtain mixed air with an increased temperature (39.5° C.) but maintains a relatively high humidity (99.1%). The mixed air is passed through condenser 32 and warmed which will result in its temperature being increased (90.4° C.) and relative humidity decreased (9.8%). The air can be warmed with heating element 35 operating at 75 kW to increase the air temperature (110.5° C.) and decrease the relative humidity (4.7%) further still.

In an embodiment, the method may comprise the step of splitting the spent air in at least two airflow portions, wherein the first air portion may comprise at least 50% vol. of the spent air being redirected towards the evaporator, and wherein the first air portion may comprise at least 50%. Vol. being redirected towards the condenser; preferably at least 60% vol. towards the evaporator, and 40% vol. towards the condenser; even more preferably, at least 70% vol. towards the evaporator, and 30% vol. towards the condenser; even more preferably still, at least 80% vol. towards the evaporator, and 20% vol. towards the condenser; even more preferably still, at least 90% vol. towards the evaporator, and 10% vol. towards the condenser; even more preferably still, 100% vol. towards the evaporator with no air towards the condenser. Advantageously these splitting rates allow for the majority of the heat being captured irrespective of the typology of product to be dried, and its initial moisture content, and successfully enables an efficient heat recovery in the presence of varying level of humidity present in the spent air. This allows for increased flexibility and suitability of the method at stake towards a broad range of wet industrial goods.

Continuing with FIG. 9, it is shown how the outside air may be warmed by means of waste heat from MW drying device 20 and its electrical components. Specifically, the outside air having an ambient temperature (20.0° C.) and high relative humidity (80%) as compared to the first air circulation. After heating the outside air will have its temperature increased (68.7° C.) and relative humidity decreased (6.3%) such that it can function as a third air circulation supplied to the microwave cavity 21.

Advantageously the outside air may function as cooling air for the electrical components while taking up latent waste heat.

In an embodiment, the method may comprise the step of capturing and advantageously removing excess moisture generated within the MW drying device by removing spent circulated air and providing new circulated air during the microwave drying process. Advantageously, this enables the MW drying device to operate at lower level of product moisture/saturation, which otherwise would hinder the MW drying speed due to air due exceeding humidity. This in turns can enable faster drying operations, as well as enabling the air within the MW drying device to become progressively less humid/less saturated with moisture, enabling the temperature within the MW drying device to be kept lower than the maximum product temperature.

1. Method for energy-efficient hybrid drying of industrial goods such as raw materials, the method comprising the steps:
providing a wet product;
preconditioning the product by successively exposing it to first air circulation circulated through a first air circulation device (11), and a second air circulation circulated through a second air circulation device (12);
hybrid drying the product by simultaneously exposing it to microwaves generated by a microwave drying device (20) and a third air circulation circulated through the microwave drying device (20);
whereby the second air circulation circulated in the second air circulation device (12) comprises spent air from the first air circulation device (11), that is warmed up and dehumidified using a heat pump system (30) such that the second air circulation has a lower relative humidity and a higher temperature than the first air circulation;
whereby the first air circulation circulated in the first air circulation device (12) comprises the spent air from the microwave drying device (20), that is warmed up and humidified in the microwave drying device (20) such that the first air circulation has a higher relative humidity and a higher temperature than the third air circulation.

2. The method according to preceding claim 1, wherein the third air circulation comprises outside air and/or the spent air from the second air circulation device (12), preferably warmed up with waste heat from the microwave drying device (20).

3. The method according to claim 2, wherein the third air circulation comprises at least 10% vol. of the spent air from the second air circulation device (12), preferably 20% vol., more preferably 30% vol., more preferably still 40% vol, more preferably still 50% vol.

4. The method according to one of the preceding claims, wherein the first air circulation device (11) and the second air circulation device (12) are arranged such that the first air circulation cannot pass directly from the first air circulation device (11) into the second air circulation device (12).

5. The method according to one of the preceding claims, wherein the first air circulation is further warmed up by a heating element (40).

6. The method according to one of the preceding claims whereby the spent air from the first air circulation device (11) is split into at least two air portions by the heat pump system (30), including a first air portion which passes through an evaporator (31), and a second air portion which bypasses said evaporator (31) and is mixed with the first air portion having passed through the evaporator to obtain mixed air; and whereby said mixed air passes through a condenser (32) and is heated obtain the second air circulation.

7. The method according to claim 6 wherein the first air portion comprises at least 50% vol. of the spent air from the first air circulation device (11), preferably 60% vol., more preferably 70% vol., even more preferably 80% vol; even more preferably still 90% vol.; even more preferably still 100% vol.

8. System (1) for energy-efficient hybrid drying of industrial goods such as raw materials, the hybrid drying system (1) comprising:
a preconditioning system (10) comprising a first air circulation device (11) configured for exposing a product to a first air circulation, and a second air circulation device (12) configured for exposing the product to a second air circulation;
a heat pump system (30) configured for receiving spent air from the first air circulation device (11), warming and dehumidifying said spent air, and feeding it to the second air circulation device (12) such that the second air circulation has a lower relative humidity and a higher temperature than the first air circulation;
a microwave drying system (20) comprising a microwave generator for generating microwaves, a microwave emission source configured for exposing the product to the generated microwaves, and a third air circulation device configured for simultaneously exposing the product to a third air circulation;
an air circulation means configured to receive spent air from the microwave drying system (20), which is warmed up and humidified in the microwave drying device (20), and feeding it to the first air circulation device (11) such that the first air circulation has a higher relative humidity and a higher temperature than the third air circulation; and,
a conveyor means (5) configured to convey a product successively through the first air circulation device (11), the second air circulation device (12) and the microwave drying device (20).

9. The hybrid drying system (1) according to preceding claim 8, whereby the preconditioning system (10) is arranged such that the first air circulation cannot pass directly from the first air circulation device (11) into the second air circulation device (12), and the second air circulation cannot pass directly from the second air circulation device (12) into the first air circulation device (11).

10. The hybrid drying system (1) according to preceding claim 8, whereby the third air circulation comprises outside air and/or the spent air from the second air circulation device (12), that is preferably warmed up with waste heat from the microwave drying device (20).

11. The hybrid drying system (1) according to one of preceding claim 8 or 9, further comprising at least one heating element (10) configured to warm up provided air.

12. The hybrid drying system (1) according to one of the preceding claims 8 to 11, wherein the heat pump system (30) comprises an evaporator (31) and a condenser (32), whereby the spent air from the first air circulation device (11) is split into at least two air portions, including a first air portion which is passed through the evaporator (31), and a second air portion which bypasses said evaporator (31) and is mixed with the first air portion having passed through the evaporator to obtain mixed air; and whereby said mixed air is passed through a condenser (32) and warmed to obtain the second air circulation.

13. The hybrid drying system (1) according to one of the preceding claims 8 to 12, wherein the conveyor device comprises a conveyor belt and/or a screw conveyor.

14. The hybrid drying system (1) according to one of the preceding claims 8 to 13, further comprising one or more solar panels configured to supply power to one or more components of said system.

15. Use of a hybrid drying system (1) according to one of the preceding claims 8 to 14 for the drying of industrial goods such as raw materials.
